(19) United States
(12) Patent Application Publication
(10) Pub. No.: US 2022/0051136 A1
(43) Pub. Date: Feb. 17, 2022

(54) SYSTEM FOR AN ENTERPRISE-WIDE DATA COORDINATOR MODULE

(71) Applicant: ELEMENT Al Inc., Montreal (CA)

(72) Inventors: Marie-Claude CÔTÉ, Montreal (CA); Alexei NORDELL-MARKOVITS, Montreal (CA); Martin PAGÉ, Montreal (CA); Andrej TODOSIC, Montreal (CA); Jean-François ARCAND, Montreal (CA)

(21) Appl. No.: 17/280,243

(22) PCT Filed: Sep. 27, 2019
(86) PCT No.: PCT/CA2019/051384

§ 371 Date: Mar. 26, 2021

Related U.S. Application Data
(60) Provisional application No. 62/738,471, filed on Sep. 28, 2018.

(51) Int. Cl. G06N 20/00; G06Q 10/06; G06Q 10/04

(52) U.S. Cl. CPC G06N 20/00; G06Q 10/04; G06Q 10/06395

(57) ABSTRACT

Systems and methods for managing multiple robotic agents in an enterprise. The robotic agents share their inputs and outputs with a data coordinator module. The coordinator module, through that data, learns the enterprise's goals and values and learns to optimize robotic agents on both a per section and on a per agent basis. The data is useful for training future versions of the coordinator module as well for training machine learning modules that aim to further the enterprise's goals.

### TECHNICAL FIELD

The present invention relates to robotic process automation (RPA) systems that perform repetitive tasks based on a programmed set of instructions. More specifically, the present invention relates to the use of machine learning as applied to such automation systems to enhance the capabilities of such systems.

### BACKGROUND

The rise of automation since the late 20th century is well documented. The application of such automated systems in manufacturing is well-known. These automated systems that perform pre-programmed, repetitive tasks are now being used not just in manufacturing but in other areas of industry and human activity. These have been used in scientific laboratories to carry out repetitive tasks that may be prone to error when executed by humans. They are now also beginning to be used in industries where they can provide error free execution of mundane, repetitive tasks. One major development in the past few years has been the rise of RPA (Robotic Process Automation). Instead of having a physical robot perform repetitive physical tasks, a robotic agent is used to perform repetitive virtual tasks on a graphical user interface. As an example, copying data from one form into another form and then saving the result is a task that RPA agents are well-suited to perform. Not only are the agents fast, they are also accurate.

While robots are useful and while they individually excel in performing such repetitive tasks, they are not coordinated as a group. Thus, efficiencies that may be had by viewing robotic agent operations as a group are usually lost opportunities. The lack of a coordinating “mind” or of an overarching “intelligence” that manages, coordinates, directs, and optimizes large groups of robotic agents can be problematic. In large enterprises that deploy hundreds if not thousands of robotic agents, different sections may, unwittingly, be duplicating the effort of other sections. As well, integration, interactions, and coordination between sections may not be as well executed as they could be. Because of this lack of coordination, inefficiencies, issues, and problems between robotic agents and between sections in the same enterprise may arise. As an example, one section may be producing data in one format and this data may be used by multiple other sections. However, if the format in which the data is produced does not accord with the format in which the data is to be used, an extra step of format translation may need to be performed. Such inefficiencies, while minor, may add up to large dollar amounts once multiplied across an entire enterprise

Based on the above, there is therefore a need for systems and methods that can coordinate multiple robotic agents across an enterprise. It is preferred that such systems and methods are also able to detect opportunities for efficiencies and optimization across different sections of the enterprise.

### SUMMARY

The present invention provides systems and methods for managing multiple robotic agents in an enterprise. The robotic agents share their inputs and outputs with a data coordinator module. The coordinator module, through that data, learns the enterprise's goals and values and learns to optimize robotic agents on both a per section and on a per agent basis. The data is useful for training future versions of the coordinator module as well for training machine learning modules that aim to further the enterprise's goals.

In a first aspect, the present invention provides a system for coordinating data exchanges and data gathering, the system comprising:
a plurality of robotic agents for executing a plurality of tasks across an enterprise, each of said plurality of robotic agents receiving data inputs for processing and each of said plurality of robotic agents producing outputs for use by one or more other robotic agents;
a data coordinator module for gathering and processing data from said plurality of robotic agents, each of said plurality of robotic agents sending at least its input and its output to said coordinator module, said data coordinator module being coupled to each of said plurality of robotic agents;

wherein
said coordinator module comprises a plurality of machine learning modules for continuously learning conditions in said enterprise through data provided by said plurality of robotic agents, said plurality of machine learning modules including at least one of.
   an optimization module for detecting data flows between robotic agents that can be optimized;
   an efficiency module for determining at least one robotic agent whose task can be rendered more efficient;
      an intent determination module for determining an intent for a task or step based on said data received from said at least one robotic agent;
      a context determination module for determining a context of at least one task or action for at least one of said robotic agents, said context being determined based on said data received from said at least one robotic agent;
   an integration module for determining one or more robotic agents whose tasks and/or execution can be integrated with that of other robotic agents; and
   an interaction module for determining one or more robotic agents whose interactions can be improved for better overall efficiency and/or optimization.

### BRIEF DESCRIPTION OF THE DRAWINGS

The present invention will now be described by reference to the following FIGURES, in which identical reference numerals refer to identical elements and in which:

FIG. 1 is a block diagram of a system according to one aspect of the present invention.

### DETAILED DESCRIPTION

The present invention relates to systems and methods for managing and coordinating a plurality of robotic agents deployed across multiple sections of an enterprise. Currently, robotic agents across an enterprise are not able to coordinate or communicate across the enterprise and across multiple sections. Thus, robotic agents in accounting may not coordinate or communicate with robotic agents in manufacturing or in marketing. Such a lack of coordination represents lost opportunities for new ventures, efficiencies, and optimizations.

In one aspect, the present invention provides a system that has a data coordinator module or subsystem that receives data from all of the robotic agents in an enterprise. These robotic agents, while executing their various tasks, send their input data and their output data to the data coordinator module. These robotic agents, regardless of the section they belong to and regardless of the task being executed, report their data to the coordinator module. The coordinator module can then process such data to obtain an enterprise-wide view of the various data flows involving robotic agents as well as the processes being dealt with by these robotic agents. The large volume of data that this system generates can be used for a number of ends. Among other uses, the data can be used to determine data dependencies between the data flows from different sections of the enterprise these dependencies can be reduced to result in greater efficiencies. In addition, the ordering of the execution of different tasks both within and across sections can be reworked to, again, result in less data dependencies and a more efficient execution of tasks across the enterprise.

The data generated can also be used to increase coordination between sections by determining mismatches between data formats, especially for data sets that would need to be used by different sections (e.g. a data set used by accounting may not have the same format as originally generated by manufacturing). Such mismatches can be flagged for action to a user in a suitable report. On a per section level, the data can be used to optimize the tasks of different robotic agents within that section. By determining the data flows within a section, optimization and efficiencies can be had within that section. Across different sections, the same process can be applied to achieve better utilization of robotic agents and their capabilities. In addition to potentially producing efficiencies within sections, integration between and across sections can be achieved by determining bottlenecks and technical/data issues that prevent greater integration between the robotic agents in different sections. As an example, if a data set used by multiple robotic agents in multiple sections is produced by only one section, then allocating more robotic agents to speed up the production of that data set should also speed up the processes for the other sections using that data set.

In addition to the above, the volumes of data produced by the various robotic agents can also be used to train better versions of the machine learning modules that the current data coordinator module uses. As more and more data becomes available, the training data sets allow the machine learning modules (e.g. neural network modules) to learn more about not just the data flows but about the enterprise and its goals as a whole. Since the data encompasses the whole enterprise, the machine learning modules can be tweaked to produce results that are more in-line with the enterprise's goals and values. The data can also be used to training other machine learning modules that can be optimized to further achieve the enterprise's goals as learned from the data.

Also, the training data sets can be further used to allow the various learning machine modules to learn about the system and/or about the enterprise as a whole. As an example, the data from the various robotic agents can reveal to the various learning machine modules what the different sections are, how each section works, and what each section is concerned with. This can be done by machine learning assisted analysis of the inputs and outputs of the various robotic agents. The context of the various data flows and/or of the various inputs and outputs to the various robotic agents can thus be learned by the machine learning modules inside the data coordinator module. Also, the intent of the various sections and/or of the enterprise as a whole can also be learned by these machine learning modules. As above, the intent can be determined using the volumes of data generated by the robotic agents from the various sections. By collating, understanding, and learning the data from the enterprise as a whole, a better picture of the enterprise as a whole, along with that enterprise's goals and values, can be determined from the data. The context and/or intent of each section and of the enterprise as a whole can be found.

With the context and intent of the various sections and of the enterprise as a whole being continuously learned by the various machine learning modules, the data coordinator module can determine what changes and/or adjustments maybe needed to each section and/or to the enterprise as a whole. Once these changes and/or adjustments have been determined, the robotic agents can then be used by the data coordinator module as appendages by which the adjustments are implemented. As an example, if faster processing is needed in section A, the data coordinator module can reallocate robotic agents from section B to operate on the data from section A. Or, if the enterprise as a whole is suffering from a drop in electricity (perhaps as a result of a power failure or rolling blackouts in the area), the data coordinator can power down some robotic agents to thereby reallocate resources to critical systems or to robotic agents that are executing mission critical tasks.

Further to the above, the data coordinator module can also determine, on a more abstract level, the goals and/or values of the enterprise and can determine how to further those goals using the robotic agents as its tools. Thus, if the data coordinator module determines, from the data gathered throughout the enterprise, that one of the enterprise's goals is to maximize the utilization of green or environmentally friendly technologies or methods, the data coordinator module can operate the robotic agents in certain sections that take power from a coal fed plant to minimize operations while robotic agents in sections that operate based on wind power are given more tasks. In addition, higher level business decisions can also be determined by the data coordinator module based on the learned goals and/or values of the enterprise. Thus, as an example, if it is determined that an enterprise goal is to minimize holdings in, again, environmentally unfriendly companies (i.e. non-green companies), the robotic agents that operate to trade stocks can be commanded to sell and/or short stocks in coal companies or in companies that do not conform to certain environmental standards. Similarly, robotic agents that operate machinery in environmentally unfriendly areas can be given less tasks while those robotic agents that operate machinery in environmentally friendly areas are given more tasks. The data coordinator module can, based on the data generated, determine enterprise-wide strategic goals and, with sufficiently trained machine learning modules, implement measures to achieve those goals. Those goals can thus be achieved by using the robotic agents as the tools to implement changes within the enterprise.

It should be clear that, in one implementation, the system of the present invention operates as a large processing unit with the coordinator module as the main processing unit. The robotic agents throughout the enterprise operate as “sensors” to gather data and to send that data to the coordinator module. The coordinator module then processes the data to optimize processes and/or tasks across the enterprise or to optimize tasks and processes within sections while using the robotic agents as the tools by which the optimizations are implemented. As well, the coordinator module may use that large amount of data to learn more about how to more optimally achieve the enterprise's goals. These ends can be achieved by suitably training multiple machine learning modules that implement different models. The machine learning modules may be trained with the large data set produced by the robotic agents and may use different cost functions to ensure that the desired end result (or the desired goal) is highlighted or optimized. In addition, the various machine learning modules may use different artificial intelligence methods such as active learning, reinforcement learning, and continuous learning to continuously receive and train on new incoming data.

In one aspect of the present invention, the coordinator module may use multiple machine learning modules or sub-modules to achieve the above ends. To this end, the coordinator module may include at least one or more machine learning modules dedicated to efficiency (an efficiency module), integration (an integration module), interaction between sections and/or between robotic agents (an interaction module), and optimization (an optimization module). In addition, the coordinator module may include a context module and an intent module. The context module can determine the context for the various tasks and/or the various data flows/data received while the intent module can determine the perceived intent or desired end result for these tasks and/or data flows. These modules can be used to enhance results within a section and/or between sections in the enterprise, or across the enterprise as a whole.

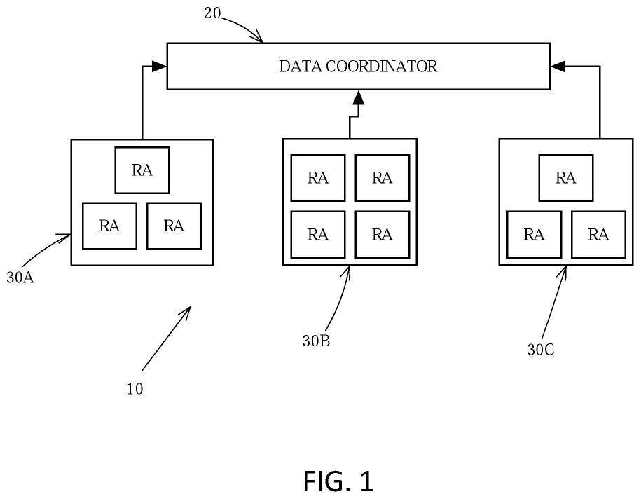

Referring to FIG. 1, a block diagram according to one aspect of the invention is illustrated. The system 10 includes a data coordinator module 20 and a number of robotic agents RA that are grouped into sections 30A, 30B, 30C. Each section may be a section or department in an enterprise and may operate in conjunction with the other sections. The robotic agents in each section may communicate with each other or with robotic agents in other sections either directly or through the coordinator module 20.

It should be clear that the system 10 in FIG. 1 is for use in gathering data from each of the sections and from the robotic agents in each of the sections. The data may be gathered in a per robotic agent basis or on a per section basis. However, the granularity of gathering data on a per robotic agent basis may render the data more useful.

It should also be clear that, in addition to gathering data from the various robotic agents, the data coordinator module may also recommend adjustments to the way robotic agents execute their tasks on a per agent basis or on a per section basis. These adjustments, some of which may be implemented without human intervention, are determined based on previously gathered data after that data has been passed through suitably trained machine learning modules. The adjustments may be applied on an iterative basis to result in adjustments that result in the best efficiencies or optimization of either the sections or of the robotic agents. In addition, the gathered data may be used to, as noted above, train better versions of the machine learning modules.

In some implementations, the robotic agents may be implemented as machine learning enabled agents such that these robotic agents are also capable of more complex behaviours and more complex decisions. For such implementations, one or more robotic agents would be equipped with at least one machine learning module and may use machine learning techniques including active learning, reinforcement learning, semi-supervised learning, supervised learning, unsupervised learning, among others. These machine learning enabled robotic agents can thus operate to manipulate data in a non-rule based manner. Such robotic agents, when coupled with physical devices for manipulating a physical environment or physical objects may be controlled by the data coordinator to optimize physical manipulative tasks. The data coordinator may thus coordinate the actions of the various robotic agents and such machine learning enabled robotic agents can independently execute their tasks. Instead of a pre-programmed robotic agent, a learning robotic agent would be tasked with specific targets and the agent can thus determine, on its own, how to best or most efficiently accomplish that task.

From the above, the machine learning enabled system and data coordinator module can gather data from a network of robotic agents across an enterprise. As such, the coordinator module can be made aware of rapidly changing conditions as detected and determined by the robotic agents. The coordinator module can thus react to such conditions quickly and efficiently with a view to furthering its goals as learned through the data.

The data coordinator module, as explained above, can thus operate as a high level coordinator of actions and/or tasks for the various machine learning enabled robotic agents. The data gathered from the various robotic agents can be used to determine new and more advanced features for later versions of the data coordinator module as well as to determine (using the intent and context modules) the deeper goals and/or motivations of the enterprise as a whole. Of course, this goal determination can be done on a per section basis and each section's robotic agents can be controlled to optimize the section's performance towards the achievement of that goal. However, on an enterprise-wide scale, the data coordinator module and its machine learning modules can learn and determine the enterprise's goals and values and can determine how to implement changes and/or adjustments in each section to achieve those enterprise goals. The data coordinator module can thus determine the enterprise's goals and use the machine learning enabled robotic agents to achieve those goals within the enterprise by having the robotic agents manipulate its environments, physical objects, or portions of the system. Thus, the coordinator module could determine an enterprise's goal or desired end result and, based on that desired end result, specific robotic agents can be tasked with a target. The specific robotic agents can then determine, on their own, how to manipulate/interact with the tools/environments within their control to thereby achieve that target. Of course, target determination and task and/or target delegation can be performed by the data coordinator module. The implementation of tasks to achieve that target can be distributed to machine learning enabled robotic agents while the performance of specific steps that contribute to the execution of those tasks can further be distributed to non-machine enabled robotic agents.

It should be clear that the various aspects of the present invention may be implemented as software modules in an overall software system. As such, the present invention may thus take the form of computer executable instructions that, when executed, implements various software modules with predefined functions.

It should be noted that the various aspects of the present invention as well as all details in this document may be implemented to address issues encountered in all manners of business related dealings as well as all manners of business issues. Accordingly, the details in this document may be used in the furtherance of any aims, desires, or values of any department in any enterprise including any end result that is advantageous for the fields of accounting, marketing, manufacturing, management, and/or human resource management as well as any expression, field, or interpretation of human activity that may be considered to be business related.

Additionally, it should be clear that, unless otherwise specified, any references herein to ‘image’ or to ‘images’ refers to a digital image or to digital images, comprising pixels or picture cells. Likewise, any references to an ‘audio file’ or to ‘audio files’ refer to digital audio files, unless otherwise specified. ‘Video’, ‘video files’, ‘data objects’, ‘data files’ and all other such terms should be taken to mean digital files and/or data objects, unless otherwise specified.

The embodiments of the invention may be executed by a data processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

What is claimed is:

1. A system for coordinating data exchanges and data gathering, the system comprising:
a plurality of robotic agents for executing a plurality of tasks across an enterprise, each of said plurality of robotic agents receiving data inputs for processing and each of said plurality of robotic agents producing outputs for use by one or more other robotic agents;
a data coordinator module for gathering and processing data from said plurality of robotic agents, each of said plurality of robotic agents sending at least its input and its output to said coordinator module, said data coordinator module being coupled to each of said plurality of robotic agents;
wherein
said coordinator module comprises a plurality of machine learning modules for continuously learning conditions in said enterprise through data provided by said plurality of robotic agents, said plurality of machine learning modules including at least one of:
an optimization module for detecting data flows between robotic agents that can be optimized;
an efficiency module for determining at least one robotic agent whose task can be rendered more efficient;
an integration module for determining one or more robotic agents whose tasks and/or execution can be integrated with that of other robotic agents;
an intent determination module for determining an intent for a task or step based on said data received from said at least one robotic agent;
a context determination module for determining a context of at least one task or action for at least one of said robotic agents, said context being determined based on said data received from said at least one robotic agent; and
an interaction module for determining one or more robotic agents whose interactions can be improved for better overall efficiency and/or optimization.

2. The system according to claim 1, wherein data gathered by said data coordinator module from said robotic agents is used in training sets to train at least one future version of said data coordinator module.

3. The system according to claim 1, wherein said data coordination module determines potential efficiency gains by reorganizing data flows between robotic agents and details said potential efficiency gains and said data flows in at least one report to a user.

4. The system according to claim 1, wherein said coordinator module coordinates data flows between different sections of said enterprise by coordinating data exchanges and formats between robotic agents from said different sections.

5. The system according to claim 1, wherein said coordinator module determines potential integration steps for increasing integration between different sections in said enterprise by determining commonalities between data formats and data related processes executed by robotic agents in said different sections.

6. The system according to claim 1, wherein said coordinator module creates a report detailing said potential integration steps for a user, said report detailing said commonalities.

7. The system according to claim 1, wherein at least one of said robotic agents is machine learning enabled.
